(19) United States
(12) Patent Application Publication
(10) Pub. No.: US 2017/0019304 A1
(43) Pub. Date: Jan. 19, 2017

(54) METHOD AND SYSTEM FOR VIRTUALIZING NETWORK CARDS ON NETWORK PROCESSING PLATFORM

(71) Applicants: INSTITUTE OF ACOUSTICS, CHINESE ACADEMY OF SCIENCES, Beijing (CN); BEIJING INTELLIX TECHNOLOGIES CO. LTD., Beijing (CN)

(72) Inventors: Wu ZHANG, Beijing (CN); Qiuli SHANG, Beijing (CN); Jinlin WANG, Beijing (CN); Xiuyan GUO, Beijing (CN)

(21) Appl. No.: 15/122,035

(22) PCT Filed: Dec. 10, 2014
(86) PCT No.: PCT/CN2014/093461

§ 371 Date: Aug. 26, 2016

(30) Foreign Application Priority Data
Feb. 27, 2014 (CN) 201410069399.9

(51) Int. Cl. H04L 12/24; H04L 12/803; H04L 12/26

(52) U.S. Cl. CPC H04L 41/0893; H04L 43/10; H04L 47/125; H04L 43/18

(57) ABSTRACT

The present invention provides a system and method for virtualizing network cards on a network processing platform. The system comprises: a network card monitoring module, used for collecting basic information of physical network cards on a network processing platform, and monitoring states of the physical network cards; a user configuration interface, used for receiving customized logical network card configuration information, and sending the received logical network card configuration information to a function configuration module; the function configuration module, used for implementing a working mode required by the logical network card configuration information and notifying the working mode to a management and scheduling module and a data sending and receiving module; the management and scheduling module, used for parsing a notification received from the function configuration module, and scheduling hardware resources of a plurality of physical network cards on the network processing platform to perform virtualization configuration on the scheduled physical network cards; and the data sending and receiving module, used for establishing, according to the working mode of logical network cards and the virtualization configuration, a correspondence between the logical network cards and the physical network cards in a data sending and receiving process by means of a mapping table, and used for sending or receiving data.

### FIELD OF THE INVENTION

The present invention relates to computer systems and virtualization technologies, and particularly to a method and system for virtualizing network cards on a network processing platform.

### BACKGROUND OF THE INVENTION

Under the background of rapid development in new concepts such as the triple-play (i.e. the integration of telecommunication, Internet and broadcasting networks), cloud computing and Internet of Things, various network data applications with high speed and low latency have gained a sustained growth continuously promoted by market demand. These high-speed network data applications raise higher requirements on the performance of network data processing, while bringing greater challenges to the management of system resources in a host computer.

In recent years, as the virtualization technology has become increasingly mature and a large number of successful cases emerge, more and more enterprises begin to pay close attention to the virtualization technology. Many manufacturers also launch their own I/O virtualization technologies and products, including, for example, IDD architecture of Xen and VIOS architecture of IBM implemented based on software technology, and VT-d technology of Intel and IOMMU technology of AMD implemented based on hardware technology. Objectives of these technologies are consistently aimed to abstract and virtualize I/O device resources to provide them to virtual machines and meet the requirements on security, reliability and performance.

However, these schemes all focus on the virtualization of the underlying hardware devices, and lack specific optimization for upper-layer applications, especially for user-oriented functional requirements.

### SUMMARY OF THE INVENTION

An objective of the present invention lies in that in order to overcome the defect of the prior art, the present invention proposes a method and system for virtualizing network cards on a network processing platform.

In order to achieve the above objective, the present invention provides a system for virtualizing network cards on a network processing platform, the said system comprising: a network card monitoring module, a functional configuration module, a management scheduling module, a data transceiving module, and a user configuration interface, wherein:

the network card monitoring module is configured to collect basic information of various physical network cards on the network processing platform, and simultaneously monitor state change of the various physical network cards in real time;

the user configuration interface is configured to receive user-customized logical network card configuration information, and send the received logical network card configuration information to the functional configuration module;

the functional configuration module is configured to implement an operating mode required by the logical network card configuration information, and notify the management scheduling module and the data transceiving module of the operating mode;

the management scheduling module is configured to parse the notification received from the functional configuration module, and then schedule hardware resources of several physical network cards on the network processing platform to perform virtualization configuration on the scheduled physical network cards; and

the data transceiving module is configured to establish a corresponding relationship between a logical network card and the physical network cards during data transmission and reception in the form of a mapping table according to the operating mode and the virtualization configuration of the logical network card, and send a network data packet sent by the logical network card to the network through a corresponding physical network card and submit a data packet received from the network by the physical network card to the corresponding logical network card.

Optionally, said network card monitoring module comprises:

a network card information statistics submodule configured to collect the basic information of the various physical network cards on the network processing platform, and send the collected basic information to the management scheduling module to generate the logical network card by the management scheduling module; and

a state monitoring submodule configured to monitor the state change of the various physical network cards in real time, and notify the management scheduling module of the obtained state change information to schedule the hardware resources of the physical network cards according to actual conditions.

Said basic information comprises: a type, a MAC address, an IP address and an operating mode of the network cards.

Said operating mode comprises: port isolation, link aggregation or load balancing.

In addition, the present invention further provides a method for virtualizing network cards on a network processing platform, said method comprising:

step 101): collecting basic information of various physical network cards on the network processing platform, and monitoring state change of the various network cards in real time;

step 102): receiving user-customized logical network card configuration information; and

step 103): implementing a corresponding network function and scheduling hardware resources of the physical network cards on the network processing platform to perform corresponding virtualization configuration according to the user-customized logical network card configuration information.

After said step 103), the method further comprises:

step 104): sending a network data packet sent by a logical network card to the network through a corresponding physical network card, and submitting a data packet received from the network by the physical network card to the corresponding virtual network card according to functional configuration information of the logical network card.

Said step 104) further comprises:

step 104-11): receiving the network data packet sent by the logical network card and performing network protocol processing on the network data packet; and

step 104-12): sending the processed network data packet to the network through the corresponding physical network card, and submitting the data packet received from the network by the physical network card to the corresponding virtual network card according to the functional configuration information of the logical network card.

Said step 104) further comprises:

step 104-21): receiving from the network, by the physical network card, a data packet transmitted over the network, and performing network protocol processing on the network data packet; and

step 104-22): submitting the processed data packet to the corresponding virtual network card according to the functional configuration information of the logical network card.

In view of the above problems, in order to further enhance virtualization capabilities of the existing networks and provide an upper-layer user with more convenient and easy-to-use functions, there exists a need to virtualize physical network cards on a network processing platform into a configurable logical network card so as to implement a plurality of customizable operating modes.

As compared with the prior art, the advantageous effects of the present invention are: a method and system for virtualizing network cards on a network processing platform are provided with the purpose of meeting a variety of functional requirements of an upper-layer user by virtualizing physical network cards on a network processing platform into a configurable logical network card so as to implement a plurality of customizable operating modes. An objective of the present invention is to meet a variety of functional requirements of an upper-layer user by virtualizing physical network cards on a network processing platform into a configurable logical network card so as to implement a plurality of customizable operating modes.

### BRIEF DESCRIPTION OF THE DRAWINGS

FIG. 1 is a structural diagram of a method and system for virtualizing network cards on a network processing platform according to the present invention;

FIG. 2 is a workflow diagram of the method and system for virtualizing network cards on a network processing platform according to the present invention.

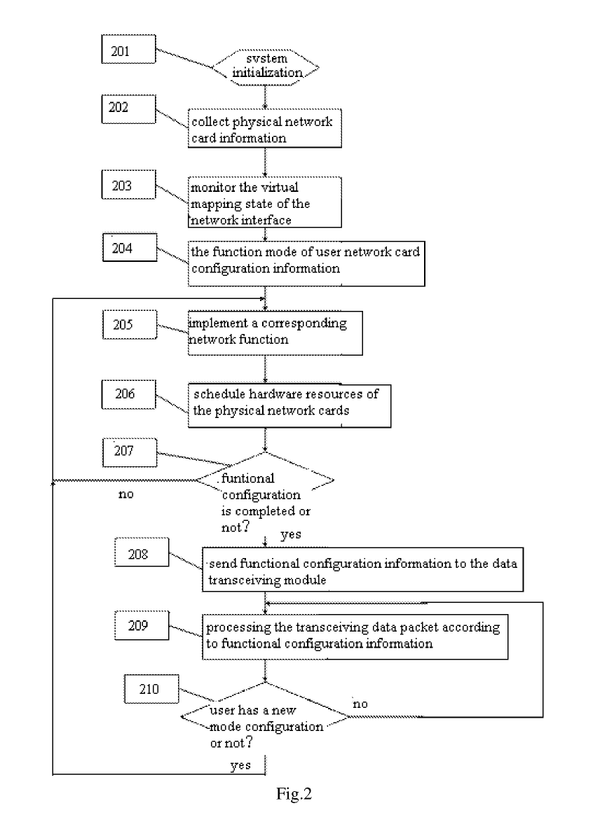

### DETAILED DESCRIPTION OF THE INVENTION

In order to make the above objectives, features and advantages of the present invention more apparent and easily understood, the present invention will be described in further detail in conjunction with the accompanying drawings and embodiments.

The present invention is implemented by the following technical solution.

The method of the present invention virtualizes physical network cards on a network processing platform into a configurable logical network card, so as to meet a variety of functional requirements of an upper-layer user. The system of the invention comprises a network card monitoring module, a functional configuration module, a management scheduling module, a data transceiving module, and a user configuration interface. In the method, the network card monitoring module collects basic information of various physical network cards on the network processing platform, the functional configuration module implements a corresponding function and a corresponding operating mode according to a user configuration mode obtained from the user configuration interface, and the management scheduling module performs virtualization configuration on resources of the physical network cards, thereby finally obtaining a logical network card conforming with the user functional configuration.

The network card monitoring module is responsible for collecting the basic information of the various physical network cards on the network processing platform comprising a type, a MAC address, an IP address and an operating mode of the network cards, and simultaneously monitoring state change of the various network cards in real time.

The functional configuration module further implements a corresponding network function according to a user-customized logical network card configuration mode such as load balancing, network interface aggregation and network data forwarding obtained through the user configuration interface, and notifies the management scheduling module of configuring the physical network cards into a corresponding operating mode.

The management scheduling module parses the notification received from the functional configuration module, and schedules hardware resources of the physical network cards on the network processing platform to perform corresponding virtualization configuration.

The data transceiving module sends a network data packet sent by a logical network card after the network data packet is processed to the network through a correspond physical network card, and submit a data packet received from the network by the physical network card after the data packet is processed to the corresponding virtual network card.

The workflow of configuring a logical network card according to the user functional requirements by the method is as follows:

step 1: in a system initialization phase, a network card monitoring module collects basic information of various physical network cards on a network processing platform comprising a type, a MAC address, an IP address and an operating mode of the network cards, and monitors state change of the various network cards in real time. After the completion of system initialization, a user configuration interface available for invocation is provided to a user.

step 2: the user may send a customized logical network card configuration mode to a functional configuration module through the user configuration interface, so as to configure and generate a virtual network card meeting functional requirements by the functional configuration module and a management scheduling module.

step 2-1: the functional configuration module further implements a corresponding network function and notifies the management scheduling module of configuring the physical network cards into a corresponding operating mode, according to the user-customized logical network card configuration mode such as load balancing, network interface aggregation and network data forwarding;

step 2-2: the management scheduling module parses the notification received from the functional configuration module, and schedules hardware resources of the physical network cards on the network processing platform to perform corresponding virtualization configuration;

step 2-3: the system sends functional configuration information to a data transceiving module, and the configuration of the logical network card is finished.

step 3: the data transceiving module sends a network data packet sent by the logical network card after the network data packet is processed to the network through a corresponding physical network card, and submits a data packet received from the network by the physical network card after the data packet is processed to the corresponding virtual network card, according to the functional configuration information of the logical network card.

step 4: when the user performs a new mode configuration through the user configuration interface, return back to step 2 to reconfigure the operating mode of the logical network card.

### EXAMPLES

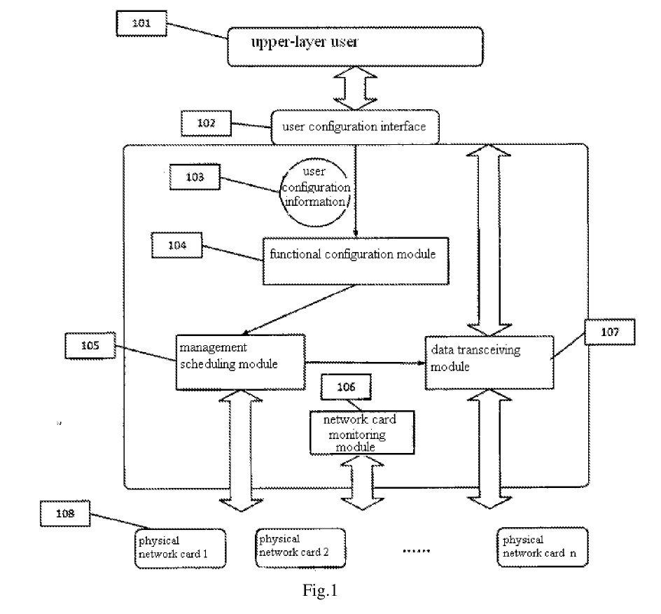

A method and system for virtualizing network cards on a network processing platform is shown in FIG. 1. The system comprises: a user configuration interface 102, a functional configuration module 104, a management scheduling module 105, a data transceiving module 107, and a network card monitoring module 106. In the method, the network card monitoring module 106 collects basic information of various physical network cards 108 on the network processing platform, the functional configuration module 104 implements a corresponding function and a corresponding operating mode according to user configuration information 103 obtained from the user configuration interface 102, and the management scheduling module 105 performs virtualization configuration on resources of the physical network cards, thereby finally obtaining a logical network card conforming with the user functional configuration.

In this embodiments, a workflow of the method of the present invention is as follows.

Steps 201, 202 and 203: in a system initialization phase, the network card monitoring module 106 collects basic information of various physical network cards 108 on the network processing platform comprising a type, a MAC address, an IP address and an operating mode of the network cards, and monitors state change of the various network cards in real time. After the completion of system initialization, the user configuration interface 102 available for invocation is provided to a user.

The user may send a customized logical network card configuration information 103 to the functional configuration module through the user configuration interface 102, so as to configure and generate a virtual network card meeting functional requirements by the functional configuration module 104 and the management scheduling module 105.

Steps 204 and 205: the functional configuration module 104 further implements a corresponding network function and notifies the management scheduling module 105 of configuring the physical network cards into a corresponding operating mode, according to the user-customized logical network card configuration information 103 such as load balancing, network interface aggregation and network data forwarding.

Step 206: the management scheduling module 105 parses the notification received from the functional configuration module 104, and schedules hardware resources of the physical network cards 108 on the network processing platform to perform corresponding virtualization configuration.

Step 207: determine if the functional configuration of the current system is complete, and if yes, proceed to step 208; if not, return back to step 205 to continue to perform the configuration.

Step 208: the system sends functional configuration information to the data transceiving module 107.

Step 209: the data transceiving module 107 sends a network data packet sent by the logical network card after the network data packet is processed to the network through a corresponding physical network card, and submits a data packet received from the network by the physical network card after the data packet is processed to the corresponding virtual network card, according to the functional configuration information of the logical network card.

Step 210: when the user performs a new mode configuration through the user configuration interface, return back to step 205 to reconfigure the operating mode of the logical network card.

In summary, the present invention relates to computer systems and virtualization technologies, and particularly to a method and system for virtualizing network cards on a network processing platform. The present invention virtualizes the physical network cards on the network processing platform into a configurable logical network card, so as to meet a variety of functional requirements of an upper-layer user. The system comprises a network card monitoring module, a functional configuration module, a management scheduling module, a data transceiving module, and a user configuration interface. In the method, the network card monitoring module collects basic information of various physical network cards on the network processing platform, the functional configuration module implements a corresponding function and a corresponding operating mode according to a user configuration mode obtained from the user configuration interface, and the management scheduling module performs virtualization configuration on resources of the physical network cards, thereby finally obtaining a logical network card conforming with the user functional configuration. The present invention is capable of meeting a variety of functional requirements of an upper-layer user by virtualizing physical network cards on a network processing platform into a configurable logical network card so as to implement a plurality of customizable operating modes.

Finally, it should be noted that the aforementioned embodiments are only used for illustrating, rather than limiting the technical solution of the present invention. Although the present invention has been described in detail with reference to the embodiments, those skilled in the art will understand that modifications or equivalent substitutions can be made to the technical solution of the present invention without departing from the scope and spirit of the technical solution of the present invention, and thereby should all be encompassed by the claims of the present invention.

1. A system for virtualizing network cards on a network processing platform, said system comprising:
a network card monitoring module, a functional configuration module, a management scheduling module, a data transceiving module, and a user configuration interface, wherein:
the network card monitoring module is configured to collect basic information of various physical network cards on the network processing platform, and simultaneously monitor state change of the various physical network cards in real time;
the user configuration interface is configured to receive user-customized logical network card configuration information, and send the received user-customized logical network card configuration information to the functional configuration module;
the functional configuration module is configured to implement an operating mode required by the user-customized logical network card configuration information, and notify the management scheduling module and the data transceiving module of the operating mode;
the management scheduling module is configured to parse the notification received from the functional configuration module, and then schedule hardware resources of several physical network cards on the network processing platform to perform virtualization configuration on the scheduled physical network cards; and
the data transceiving module is configured to establish a corresponding relationship between a logical network card and the physical network cards during data transmission and reception in the form of a mapping table according to the operating mode and the virtualization configuration of the logical network card, and send a network data packet sent by the logical network card to the network through a corresponding physical network card and submit a data packet received from the network by the physical network card to the corresponding logical network card.

2. The system for virtualizing network cards on a network processing platform according to claim 1, wherein the network card monitoring module comprises:
a network card information statistics submodule configured to collect the basic information of the various physical network cards on the network processing platform, and send the collected basic information to the management scheduling module to generate the logical network card by the management scheduling module; and
a state monitoring submodule configured to monitor the state change of the various physical network cards in real time, and notify the management scheduling module of the obtained state change information to schedule the hardware resources of the physical network cards according to actual conditions.

3. The system for virtualizing network cards on a network processing platform according to claim 1, wherein the basic information comprises: a type, a MAC address, an IP address and an operating mode of the physical network cards.

4. The system for virtualizing network cards on a network processing platform according to claim 1, wherein the operating mode comprises: port isolation, link aggregation or load balancing.

5. A method for virtualizing network cards on a network processing platform, said method comprising:
collecting basic information of various physical network cards on the network processing platform, and monitoring state change of the various physical network cards in real time;
receiving user-customized logical network card configuration information; and
step implementing a corresponding network function and scheduling hardware resources of the various physical network cards on the network processing platform to perform corresponding virtualization configuration according to the user-customized logical network card configuration information.

6. The method for virtualizing network cards on a network processing platform according to claim 5, wherein, after implementing the corresponding network function and scheduling the hardware resources of the various physical network cards on the network processing platform, the method further comprises:
sending a network data packet sent by a logical network card to the network through a corresponding physical network card, and submitting a data packet received from the network by the physical network card to the corresponding virtual network card according to functional configuration information of the logical network card.

7. The method for virtualizing networks card on a network processing platform according to claim 6, wherein sending the network data packet further comprises:
receiving the network data packet sent by the logical network card and performing network protocol processing on the network data packet; and
sending the processed network data packet to the network through the corresponding physical network card, and submitting the data packet received from the network by the physical network card to the corresponding virtual network card according to the functional configuration information of the logical network card.

8. The method for virtualizing network cards on a network processing platform according to claim 6, wherein sending the network data packet further comprises:
receiving from the network, by the physical network card, a data packet transmitted over the network, and performing network protocol processing on the network data packet; and
submitting the processed data packet to the corresponding virtual network card according to the functional configuration information of the logical network card.
